(19) United States
(12) Patent Application Publication
(10) Pub. No.: US 2015/0066658 A1
(43) Pub. Date: Mar. 5, 2015

(54) PROVIDING ONLINE CONTENT FOR INTERIOR IMAGERY

(71) Applicants: Charles Chapin, San Jose, CA (US); Luc Vincent, Palo Alto, CA (US)

(72) Inventors: Charles Chapin, San Jose, CA (US); Luc Vincent, Palo Alto, CA (US)

(73) Assignee: GOOGLE INC., Mountain View, CA (US)

(21) Appl. No.: 13/197,379

(22) Filed: Aug. 3, 2011

(51) Int. Cl. G06Q 30/00; G06K 9/00

(52) U.S. Cl. 705/14.71; 382/103; 705/14.73; 705/27.2

(57) ABSTRACT

Methods, systems, and apparatus, including computer programs encoded on a computer-readable storage device, including a method for providing content. The method comprises identifying imagery associated with an interior of a structure. The method further comprises identifying one or more products or services that are shown in the imagery. The method further comprises receiving a request to provide a panorama of the interior of the structure. The method further comprises providing the panorama including providing the imagery. The method further comprises providing content responsive to the request based at least in part on the identified one or more products or services.

### BACKGROUND

This specification relates to information presentation.

The Internet provides access to a wide variety of resources. For example, video and/or audio files, as well as web pages for particular subjects or particular news articles, are accessible over the Internet. Access to these resources presents opportunities for other content (e.g., advertisements) to be provided with the resources. For example, a web page can include slots in which content can be presented. These slots can be defined in the web page or defined for presentation with a web page, for example, along with search results.

Content item slots can be allocated to content sponsors through an auction. For example, content sponsors can provide bids specifying amounts that the sponsors are respectively willing to pay for presentation of their content. In turn, an auction can be performed, and the slots can be allocated to sponsors according, among other things, to their bids and/or the relevance of the sponsored content to content presented on a page hosting the slot or a request that is received for the sponsored content.

### SUMMARY

In general, one innovative aspect of the subject matter described in this specification can be implemented in methods that include a method for providing content. The method comprises identifying imagery associated with an interior of a structure. The method further comprises identifying one or more products or services that are shown in the imagery. The method further comprises receiving a request to provide a panorama of the interior of the structure. The method further comprises providing the panorama including providing the imagery. The method further comprises providing content responsive to the request based at least in part on the identified one or more products or services.

These and other implementations can each optionally include one or more of the following features. Identifying the one or more products or services that are included in the imagery can include receiving input from a sponsor associated with the structure that includes a description of the products or services shown. The description can further include a description of blacklisted items or entities that should not be a subject of any later provided content. The description can further include a description of whitelisted items or entities that are permissible to be included in any later provided content. Identifying the one or more products or services that are included in the imagery can include automatically evaluating the imagery to identify the one or more products or services. The panorama can be a panorama of the interior of the structure. The products can be products included on shelves shown in the imagery. The services can be services rendered at a location shown in the imagery. Providing content responsive to the request can include evaluating one or more content items, ranking the one or more content items based on one or more criteria, and providing one or more highest ranking content items responsive to the request. The method can further comprise conducting an auction including evaluating bids of one or more entities that have targeted bids to the identified one or more products or services, and providing content based on a result of the auction. The content can include one or more advertisements. Providing content responsive to the request can include identifying keywords associated with the one or more products or services and using the keywords to identify relevant content.

In general, another innovative aspect of the subject matter described in this specification can be implemented in methods that include a method for targeting content. The method comprises identifying imagery associated with an interior of a structure. The method further comprises identifying one or more products or services associated with or shown in the imagery. The method further comprises, responsive to a request to display the imagery, targeting additional content to a user based at least in part on the one or more identified products or services.

These and other implementations can each optionally include one or more of the following features. Identifying the one or more products or services associated with or shown in the imagery can include receiving input from a sponsor associated with the structure that includes a description of the products or services shown. The description can further include a description of blacklisted items or entities that should not be a subject of any later provided content. The description can further include a description of whitelisted items or entities that are permissible to be included in any later provided content. Identifying the one or more products or services associated with or shown in the imagery can include automatically evaluating the imagery to identify the one or more products or services. The products can be products included on shelves shown in the imagery. The services can be services rendered at a location shown in the imagery. The targeting additional content can include evaluating one or more content items, ranking the one or more content items based on one or more criteria, and providing one or more highest ranking content items responsive to the request. The method can further comprise conducting an auction including evaluating bids of one or more entities that have targeted bids to the identified one or more products or services, and providing content based on a result of the auction. The content can include one or more advertisements. Targeting additional content can include identifying keywords associated with the one or more products or services and using the keywords to identify relevant content.

In general, another innovative aspect of the subject matter described in this specification can be implemented in systems that include a content management system that provides content responsive to received requests. The system comprises a request handler that is enabled to handle requests for imagery and requests for content items and to provide imagery in response to requests for imagery and provide content items associated with products or services associated with the imagery. The system further comprises a location engine that is enabled to determine a location associated with the imagery. The system further comprises a ranking engine that is enabled to rank content items based, at least in part, on a relevance of the content items to products or services associated with the imagery. The system further comprises an imagery identification engine that is enabled to identify imagery associated with a sponsor. The system further comprises a product/service identification engine that is enabled to identify products or services included in the imagery and that are associated with the sponsor or a location associated with the sponsor.

These and other implementations can each optionally include one or more of the following features. The content provided by the request handler can include advertisements.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment for providing content related to products or services displayed in interior imagery.

FIG. 2 is a block diagram showing an example system for providing content associated with products or services included in interior imagery of a structure.

FIG. 3A is a flowchart of an example process for providing content associated with products or services included in interior imagery.

FIG. 3B is a flowchart of an example process for providing imagery and content items associated with products or services included with imagery associated with the interior of a structure.

FIG. 4 is a block diagram of an example computer system that can be used to implement the methods, systems and processes described in this disclosure.

Like reference numbers and designations in the various drawings indicate like elements.

### DETAILED DESCRIPTION

This document describes methods, processes and systems for providing content, such as advertisements (i.e., ads), based on products or services that are displayed in interior imagery associated with a structure. For example, the structure can be a building, such as a store that sells products, or a building from which services are rendered. The imagery can include a panorama showing the inside of the structure, such as products on shelves in a store. For example, the panorama can be displayed on a user device, such as a smart phone or other mobile device. The panorama can be displayed as part of an interior view application that executes on the user's mobile device. While the user views the imagery of the structure's interior, content can be served that is associated with products or services included in the image. For example, if the user is viewing imagery showing products for sale on the shelves of an electronics store, e.g., in a viewport on the user's mobile device, ads or other content associated with one or more of those products or services can appear in a different part of the screen. In this way, content (e.g., ads) can be targeted to the user and presented in content item slots (e.g., ad slots) based on what the user sees in the interior view application.

In order to provide content items corresponding to products or services, imagery associated with the structure is identified, including associating the imagery with an entity (e.g., the store or business and its location) which sells the products or renders the services included in the imagery. Further, the products or services in the imagery are identified, e.g., by a sponsor associated with the entity (e.g., the merchant of a store) or by automatic image recognition techniques. The associations between the products or services and the imagery are stored. In this way, when a panorama or other interior imagery is displayed, content items (e.g., ads) that are relevant to the products or services in the imagery can be served (e.g., to the user viewing the products or services).

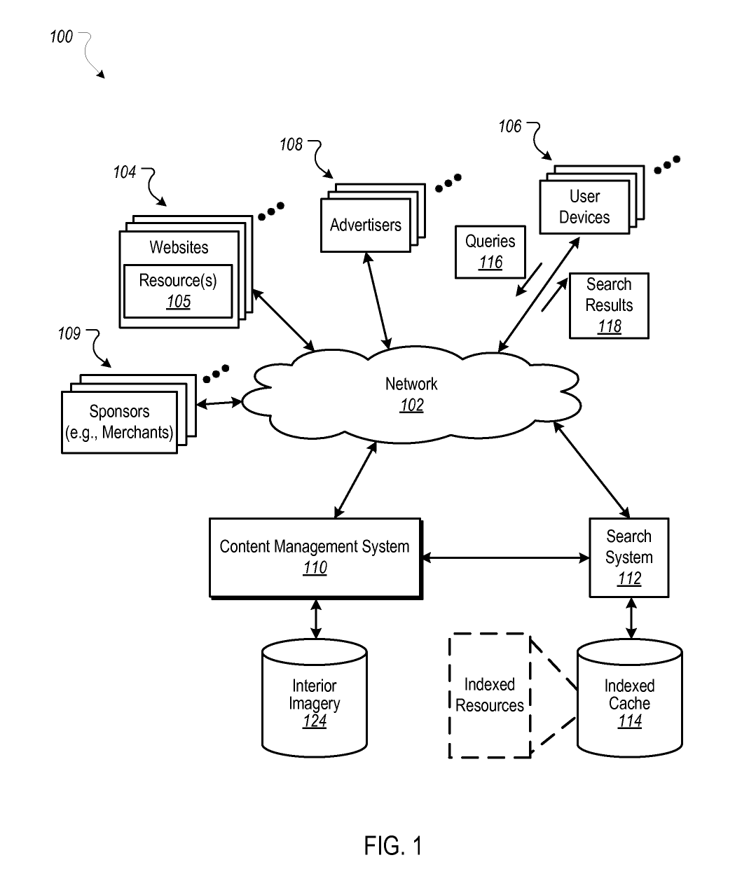

FIG. 1 is a block diagram of an example environment 100 for providing content related to products or services displayed in interior imagery. The example environment 100 includes a content management system 110 for selecting and providing content in response to requests for content. The example environment 100 includes a network 102, such as a local area network (LAN), a wide area network (WAN), the Internet, or a combination thereof. The network 102 connects websites 104, user devices 106, content providers (e.g., advertisers 108), sponsors 109 (e.g., merchants), publishers, and the content management system 110. The example environment 100 may include many thousands of websites 104, user devices 106, content providers, and sponsors 109.

A website 104 includes one or more resources 105 associated with a domain name and hosted by one or more servers. An example website is a collection of web pages formatted in hypertext markup language (HTML) that can contain text, images, multimedia content, and programming elements, such as scripts. Each website 104 can be maintained by a content publisher, which is an entity that controls, manages and/or owns the website 104.

A resource 105 can be any data that can be provided over the network 102. A resource 105 can be identified by a resource address that is associated with the resource 105. Resources include HTML pages, word processing documents, portable document format (PDF) documents, images, video, and news feed sources, to name only a few. The resources can include content, such as words, phrases, images and sounds, that may include embedded information (such as meta-information hyperlinks) and/or embedded instructions (such as JavaScript scripts).

A user device 106 is an electronic device that is under control of a user and is capable of requesting and receiving resources over the network 102. Example user devices 106 include personal computers, mobile communication devices (e.g., smartphones), and other devices that can send and receive data over the network 102. A user device 106 typically includes one or more user applications, such as a web browser, to facilitate the sending and receiving of data over the network 102.

A user device 106 can request resources 105 from a website 104. In turn, data representing the resource 105 can be provided to the user device 106 for presentation by the user device 106. The data representing the resource 105 can also include data specifying a portion of the resource or a portion of a user display, such as a presentation location of a pop-up window or a slot of a third-party content site or web page, in which content can be presented. These specified portions of the resource or user display are referred to as slots (e.g., ad slots).

To facilitate searching of these resources, the environment 100 can include a search system 112 that identifies the resources by crawling and indexing the resources provided by the content publishers on the websites 104. Data about the resources can be indexed based on the resource to which the data corresponds. The indexed and, optionally, cached copies of the resources can be stored in an indexed cache 114.

User devices 106 can submit search queries 116 to the search system 112 over the network 102. In response, the search system 112 accesses the indexed cache 114 to identify resources that are relevant to the search query 116. The search system 112 identifies the resources in the form of search results 118 and returns the search results 118 to the user devices 106 in search results pages. A search result 118 is data generated by the search system 112 that identifies a resource that is responsive to a particular search query, and includes a link to the resource. In some implementations, the content management system 110 can generate search results 118 using information (e.g., identified resources) received from the search system 112. An example search result 118 can include a web page title, a snippet of text or a portion of an image extracted from the web page, and the URL of the web page. Search results pages can also include one or more slots in which other content items (e.g., ads) can be presented. In some examples, requests for content other than, or in addition to, search queries 116 can occur, such as requests for content based on products or services displayed in interior imagery 124, as is described in this document. In these examples, no search terms are explicitly provided by the user, but keywords for which to target content items can be inferred from the products and services that the user is viewing, such as in an interior view application.

When a resource 105, search results 118 and/or other content are requested by a user device 106, the content management system 110 receives a request for content. The request for content can include characteristics of the slots that are defined for the requested resource or search results page, and can be provided to the content management system 110.

For example, a reference (e.g., URL) to the resource for which the slot is defined, a size of the slot, and/or media types that are available for presentation in the slot can be provided to the content management system 110. Similarly, keywords associated with a requested resource (“resource keywords”) or a search query 116 for which search results are requested can also be provided to the content management system 110 to facilitate identification of content that is relevant to the resource or search query 116.

Based at least in part on data included in the request, the content management system 110 can select content that is eligible to be provided in response to the request (“eligible content items”). For example, eligible content items can include eligible ads having characteristics matching the characteristics of ad slots and that are identified as relevant to specified resource keywords or search queries 116. However, in applications in which search queries 116 are not used, the content management system 110 can use other ways of selecting content, e.g., in the absence of keywords obtained from search queries 116. For example, as described within this document, the content management system 110 can select content using keywords inferred or associated with products or services included in imagery displayed on the user device 106.

The content management system 110 can select from the eligible content items that are to be provided for presentation in slots of a resource or search results page based at least in part on results of an auction. For example, for the eligible content items, the content management system 110 can receive bids from content sponsors (e.g., advertisers) and allocate the slots, based at least in part on the received bids (e.g., based on the highest bidders at the conclusion of the auction). The bids are amounts that the content sponsors are willing to pay for presentation (or selection) of their content with a resource or search results page. For example, a bid can specify an amount that a content sponsor is willing to pay for each 1000 impressions (i.e., presentations) of the content item, referred to as a CPM bid. Alternatively, the bid can specify an amount that the content sponsor is willing to pay for a selection (i.e., a click-through) of the content item or a conversion following selection of the content item. The selected content item can be determined based on the bids alone, or based on the bids of each bidder being multiplied by one or more factors, such as quality scores derived from content performance, landing page scores, and/or other factors.

A conversion can be said to occur when a user performs a particular transaction or action related to a content item provided with a resource or search results page. What constitutes a conversion may vary from case-to-case and can be determined in a variety of ways. For example, a conversion may occur when a user clicks on a content item (e.g., an ad), is referred to a web page, and consummates a purchase there before leaving that web page. A conversion can also be defined by an advertiser to be any measurable/observable user action, such as downloading a white paper, navigating to at least a given depth of a website, viewing at least a certain number of web pages, spending at least a predetermined amount of time on a web site or web page, registering on a website, experiencing media, or performing a social action regarding a content item (e.g., an ad), such as republishing or sharing the content item. Other actions that constitute a conversion can also be used.

In some implementations, the likelihood that a conversion will occur can be improved, such as by serving content that is more likely to be of interest to the user. For example, if a content item that is served is selected in part based on products or services that is included in imagery that the user is viewing, then the user may be more likely to interact with the content item. This is because the content item includes content that is more relevant to the user, e.g., may be associated with entities (e.g., businesses, restaurants, stores, etc.) and products or services that are in the user's location-of-interest.

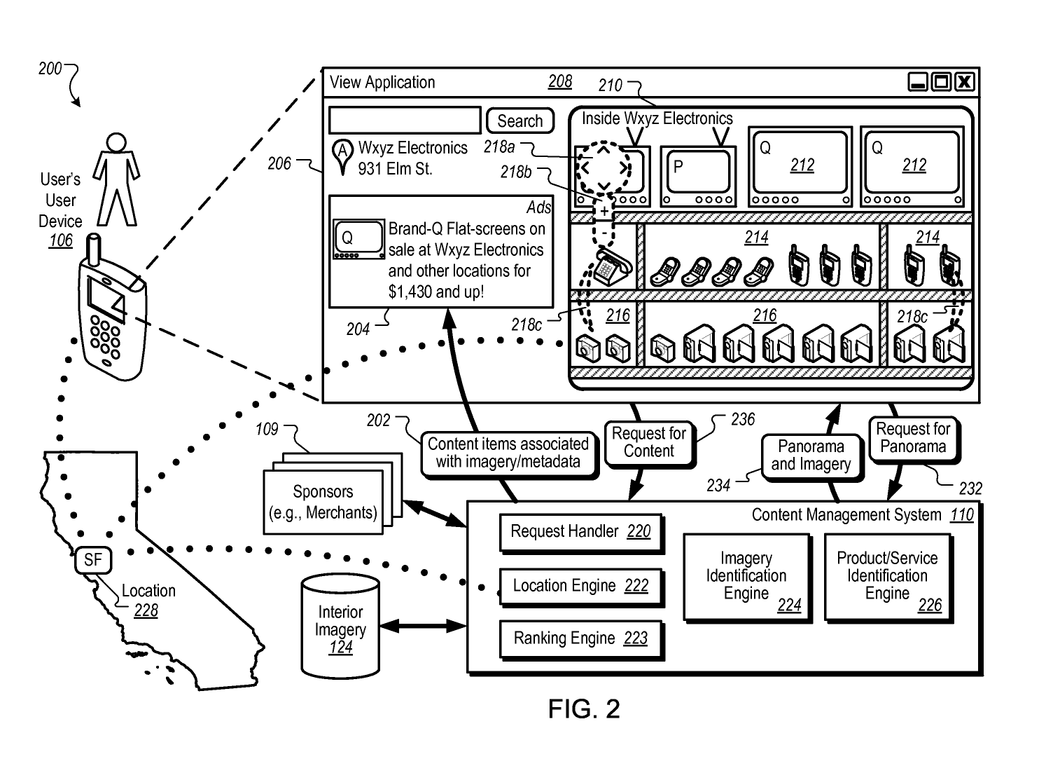

FIG. 2 is a block diagram showing an example system 200 for providing content associated with products or services included in interior imagery of a structure. In some implementations, the interior imagery can be presented as a panorama of the interior of a structure, e.g., the inside of a store. For example, the interior imagery can include images of products on shelves for sale at the store, or images of services that are rendered at a location associated with the imagery. The content management system 110 can provide the content items 202 (e.g., ads) associated with the interior imagery. For example, the content items 202 can be selected based, at least in part, on keywords derived from information associated with the products or services depicted in the imagery. The content items 202 can be used to fill one or more content item slots 204 (e.g., ad slots) on a screen 206. As a result, the screen 206 can display an ad Brand-Q flat screen televisions, for example, while the user is viewing Brand-Q flat-screens in the interior imagery.

For example, the screen 206 can appear on the user device 106 when the user is running a view application 208 (e.g., an application for viewing interior imagery in structures or buildings) or some other application that uses interior imagery. Interior imagery can include images of products or services. One example of product-related interior imagery is imagery that shows products on store shelves, such as TVs, phones, cameras and other electronic products on the shelves of an electronics store. Examples of service-related interior imagery include imagery showing various types and configurations of exercise equipment at a fitness center, restaurants, hotels, banks, cleaners or other imagery showing services offered by service-related businesses. In some examples, interior imagery can depict products and services simultaneously.

In some implementations, a viewport 210 within the view application 208 can display the interior imagery. For example, the viewport 210 can display products on the shelves of an electronics store, including televisions (e.g., flat-screen TVs 212) on a top shelf, telephones 214 on a middle shelf, and cameras 216 on a bottom shelf. The shelves shown in the viewport 210 may be, for example, just three shelves of several vertical shelves. In some implementations, the viewport can include controls 218a, 218b and 218c. For example, the controls 218a can allow the user to change the direction of the field-of-view by panning to the left or right (e.g., changing the angle of sight), or up and down (e.g., to see products on higher or lower shelves). Controls 218b can allow the user to zoom in and out in relation to the current field-of-view, e.g., to obtain a more magnified view of a product (e.g., a close-up view of flat-screen TVs 212). Controls 218c can allow the user to navigate in the left and right directions, e.g., to see other products on the shelves in the corresponding direction. In some implementations, whenever use of the controls 218a-218c causes a change as to which products or services are displayed, different content items (e.g., ads) can be served, matching the newly-displayed products or services.

In some implementations, other controls can exist for controlling the display of information in the viewport 210, such as including a direction indicator that indicates the compass direction of the field-of-view (e.g., indicating compass north). In some implementations, additional information can be presented in the viewport 210 that indicates the elevation or angle of the field-of-view, the floor or level of the structure (e.g., in a multi-floor department store), or an indication of scale (e.g., by displaying a legend with a ruler). In some implementations, ads can be displayed for products that are just out-of-sight of the current viewport, with some indication of how the user can get to that part of the store that shelves that advertised products.

In some implementations, controls and functionality of viewing interior imagery can be the same or different from controls and functionality of street view applications. In some implementations, there can be a seamless transition between what the user sees in street view applications and interior view applications. In some implementations, street view applications can indicate (e.g., with a displayed symbol) which structures or buildings in the field-of-view, if any, have associated interior imagery.

Interior imagery can be generated and obtained in various ways. In some implementations, sponsors (e.g., merchants) can subscribe to web-based or other services that allow sponsors to provide and/or annotate images of the products or services that they offer. For example, for images of products in an electronics store (e.g., Wxyz Electronics), the sponsor can identify specific brand and/or model information of televisions, telephones and cameras that are physically on the store's shelves. Using a user interface, for example, the Wxyz Electronics merchant can identify a portion of an image (e.g., as shown in the viewport 210) as being an image of Brand-Q flat-screen TVs 212.

In some implementations, associating products or services to a particular portion of an image can be facilitated by one or more applications that integrate image displays with a sponsor's (e.g., merchant's) inventory system. For example, as the merchant displays an image that includes the store shelf on which Brand-Q flat-screen TVs 212 are displayed, the merchant can select the particular brand and/or model information from a drop-down or other selection interface, where the selectable data is populated from inventory information at Wxyz Electronics. In some implementations, Brand-Q flat-screen TVs 212 or other product information can be associated with the image using tags or other meta-data that associate Brand-Q flat-screen TVs 212 with that portion of that image. When products are associated with interior imagery in this way, the content management system 110 can provide content items (e.g., ads) that are relevant to the imagery, such as providing ads related to Brand-Q flat-screen TVs 212 whenever those particular TVs are displayed in the viewport 210 by the user. Other content items that can be provided include non-Brand-Q TVs or other products that are Brand-Q products.

The content management system 110 can include plural engines, including a request handler 220 for handling requests for imagery and content, a location engine 222 for determining locations associated with requests, a ranking engine 223 for ranking content items based on a relevance of the content items to products or services associated with the imagery, an imagery identification engine 224 for identifying imagery associated with sponsors (e.g., merchants), and a product/service identification engine 226 for identifying sponsors' products or services that are included in imagery. For example, the request handler 220 can receive and handle requests for content items, e.g., ad requests from interior imagery applications such as the view application 208. The location engine 222 can be used to determine a location 228 (e.g., a place in San Francisco) associated with requests for content. For example, the location 228 can be the user's current location (e.g., determined from GPS capabilities of the user's mobile client device 106), such as if the user is in San Francisco at the time of the request. As another example, the location 228 can be a location-of-interest, such as if the user is using a map-related application and has requested (or is currently displaying) information about San Francisco. In some implementations, the user's location-of-interest can be determined automatically from a known latitude/longitude location for the structure (e.g., Wxyz Electronics) for which imagery is displayed in the current viewport 210. In some implementations, the user's location-of-interest can be determined automatically from the center point coordinates of the viewport 210, e.g., if the user has just switched from using a street view application to using the view application 208. The location engine 222 can also determine entities, such as businesses, stores, restaurants, etc. for a geographic location. In some implementations, methods described herein for selecting content may be combined with other methods.

In some examples, when the location 228 corresponds both to the user's current location and the user's location-of-interest, it can be doubly advantageous to provide content items associated with the location 228. For example, the user may be inside or near Wxyz Electronics in downtown San Francisco at the same time that the user is viewing interior imagery showing electronics-related products in Wxyz Electronics.

The ranking engine 223 can use keywords associated with products or services that are included in imagery in order to rank content items. The keywords can be obtained from descriptions or other information associated with the products or services. For example, in response to a request for content (e.g., ads) that occurs while the user is displaying an image containing Brand-Q Flat-screen TVs, the content management system 110 can select one or mode content items 202. The ranking engine 223 can rank the content items 202 based on, for example, the keywords. In this way, an ad for Brand-Q flat-screen TVs can be selected, for example, as a highest-ranked content item based on the keywords (e.g., “Brand-Q,” “flat-screen,” “TV,” “television”) that are associated with the Brand-Q flat-screen TVs 212 that the user sees in the viewport 210.

The imagery identification engine 224 can be used to associate imagery with a structure. For example, prior to the user displaying imagery for Wxyz Electronics in the viewport 210, the imagery identification engine 224 can associate the imagery with the structure. In some implementations, the association can be done by a merchant, e.g., using an Internet-based application (e.g., interfaced with the imagery identification engine 224) to upload images from the merchant's store to an online repository of images (e.g., interior imagery 124). In some implementations, the sponsor can identify associations between the sponsor's products or services and the imagery uploaded by others to the interior imagery 124.

The product/service identification engine 226 can be used to annotate particular portions of the imagery, for example, with specific product brand and/or model information. In some implementations, the product/service identification engine 226 includes, or is integrated with, applications that sponsors (e.g., merchants) can use to identify their products or services that are depicted in imagery associated with their structures. For example, the sponsor of Wxyz Electronics can use the product/service identification engine 226 to identify portions of interior imagery for his store that show Brand-Q flat-screen TVs 212. In some implementations, image recognition software can automatically identify products and/or services displayed in an image, and the information can complement (or replace the need for) sponsor input. As a result of the identification of products or services in interior imagery, the content management system 110, for example, can provide content items 202 (e.g., ads) associated with products and/or services included in the imagery.

In some implementations, products or services associated with interior imagery can be determined and/or stored on a cell-by-cell basis. For example, images can be divided into cells in vertical and horizontal dimensions, and each cell can have identified with it one or more products or services that are depicted in that cell. In some implementations, the cells can be mapped to shelves, e.g., at the Wxyz Electronics store, and the sponsor can identify the products in those cells. This information can be stored in or associated with the interior imagery 124. In some implementations, when interior imagery is accessed, the information for the cells that make up the image can also be accessed. In this way, information for products or services associated with each cell is known, such as when the image is displayed in the view application 208. In some implementations, the product/service identification engine 226 can be used to determine or use information for products or services associated with one or more cells such as to formulate keywords based on products or services in those cells so that content associated with the products or services can be determined. In some implementations, sponsors can control the size of cells, e.g., defining a different cell for each collection of various areas of one or more shelves of products.

In some implementations, the names and/or descriptions of the products or services that are associated with the imagery can be used to generate keywords that correspond to the products or services offered by the sponsor. In some implementations, keywords can also be derived from the name of the business (e.g., the keyword “electronics” from Wxyz Electronics). The keywords can be used at a later time, for example, to select content items (e.g., ads) associated with the imagery. For example, the content management system 110 can use the keywords (among other information) to select ads for Brand-Q flat-screen TVs 212 when those particular TVs or related products are displayed in the viewport 210. Keywords in this example can include “Brand-Q,” “flat-screen,” “TV,” “television” and so on. Brand-Q flat-screen TV ads or other ads selected using any number of the keywords can be displayed, for example, in content item slots 204 (e.g., ad slots). In some implementations, keywords can be included with other information stored for imagery in the interior imagery 124.

In one example sequence of events within the system 200, the merchant at Wxyz Electronics can use the imagery identification engine 224 to associate imagery with the interior of the structure or building that houses his electronics store. Other ways of associating imagery with a sponsor include, for example, automatic associations (e.g., performed by content providers), user-based associations (e.g., performed by various users who visit the merchant's location and report the associations online), or combinations thereof. Once the imagery is associated with a sponsor (e.g., Wxyz Electronics), the sponsor associated with the structure can provide descriptions of the products or services shown in the imagery. For example, the Wxyz Electronics merchant can use applications interfaced to (or integrated with) the product/service identification engine 226, for example, to identify one or more products (e.g., Brand-Q flat-screen TVs 212) or services that are shown in the imagery. The acts of associating imagery with stores and identifying products or services in the imagery can occur on an ongoing basis for various merchants. In some implementations, information corresponding to and relating the merchants, stores, products and services can be stored in or associated with the interior imagery 124. Over time, merchants can add, update and/or delete information as desired, such as whenever inventory changes or when products get moved to other shelves.

In some implementations, the description that the sponsor provides for products or services can include a description of blacklisted items or entities that should not be a subject of any later provided content. For example, when the Wxyz Electronics merchant provides information regarding the Brand-Q flat-screen TVs 212, the merchant can indicate that any content (e.g., ads) served with respect to the imagery should not include certain competing products (e.g., Brand-P and Brand-R TVs, etc.) or entities such as competitors' electronics stores (e.g., identified in a merchant-provided list of stores). In some implementations, sponsors can identify or describe whitelisted items or entities that are permissible to be included in any later provided content. For example, the Wxyz Electronics merchant may indicate that ads for Brand-S TVs and other specific products (e.g., including unrelated to TVs) are permitted when users are viewing imagery showing the merchant's Brand-Q Flat-screen TVs. In some implementations, identification of blacklisted and whitelisted products can be done on a category basis (e.g., the category of compact discs if the merchant sells only vintage vinyl records, for example).

Subsequently, a user may use an application such as the view application 208 to view interior imagery of a structure. For example, the user may start the view application 208 in order to view the interior of Wxyz Electronics and to look at the types of electronics they sell. In some implementations, when the view application 208 starts execution, the view application 208 can issue a request for panorama data 232, e.g., to the content management system 110. In some implementations, parameters or other information included in the request 232 can identify the name and/or location of the structure for which panorama data is desired. The content management system 110 can use the information, for example, to access imagery in the interior imagery 124 that corresponds to the interior of the structure to which the request 232 applies. In response to the request 232, for example, the content management system 110 can provide panorama and imagery 234. In some implementations, the request handler 220 can handle the request by receiving the request 232 and providing the panorama and imagery 234 in response. In some implementations, when the imagery is provided, the imagery can include metadata that identifies information about what products and services are associated with the imagery.

In an example of providing content associated with interior imagery, the view application 208, for example, can provide a request for content 236. In some implementations, the request for content 236 can be sent whenever new interior imagery is displayed in the viewport 210 by the view application 208. In some implementations, the request for content 236 can make use of the metadata that was provided with the imagery and that identifies information about what products and services are associated with the imagery. In some implementations, the request for content 236 can serve as a request for one or more ads that are associated with the imagery. For example, an ad request can request ads for products or services displayed in the viewport 210, including ads for Brand-Q flat-screen TVs 212. In this example, ads for Brand-Q flat-screen TVs can be requested because metadata associated with the imagery indicates that the imagery includes or is associated with Brand-Q flat-screen TVs.

In response to the request for content 236, the content management system 110, for example, can provide content items 202 (e.g., ads) associated with the imagery. The selection of the content items 202 can be based at least in part on keywords associated with products or services depicted in the imagery. The content items 202 can be used to fill content item slots 204. As a result, while the user is viewing interior imagery in the viewport 210 that shows televisions for sale at Wxyz Electronics, one or more ads for Brand-Q flat-screen TVs 212 can be served and displayed to the user.

In some implementations, the content items 202 that are provided by the content management system can depend, at least in part, on which cells, products or services in the image that the user selects in some way. For example, if the user clicks on or hovers over a product or service (or the cell that includes one or more products and/or services), then content items (e.g., ads) can be selected based on the user's selection. In some implementations, the content items 202 that are provided can depend, at least in part, on where the user's view is focused. For example, the user's focus can be assumed to be the center area of the screen, and content items 202 can be provided for products or services associated with that portion of the image. In another example, the user's focus can be determined from the mouse cursor or other pointing control, such as a control (e.g., a magnifying glass) that the user can move to different areas of the screen. In some implementations, user-focus controls can include boxes or frames that the user can reposition and resize. Other ways of determining the user's focus can be used. In some implementations, the user's focus can serve as an indication of the user's interaction with the imagery, and that interaction, plus information about what products and services are associated with the imagery, can serve as metadata used to select content.

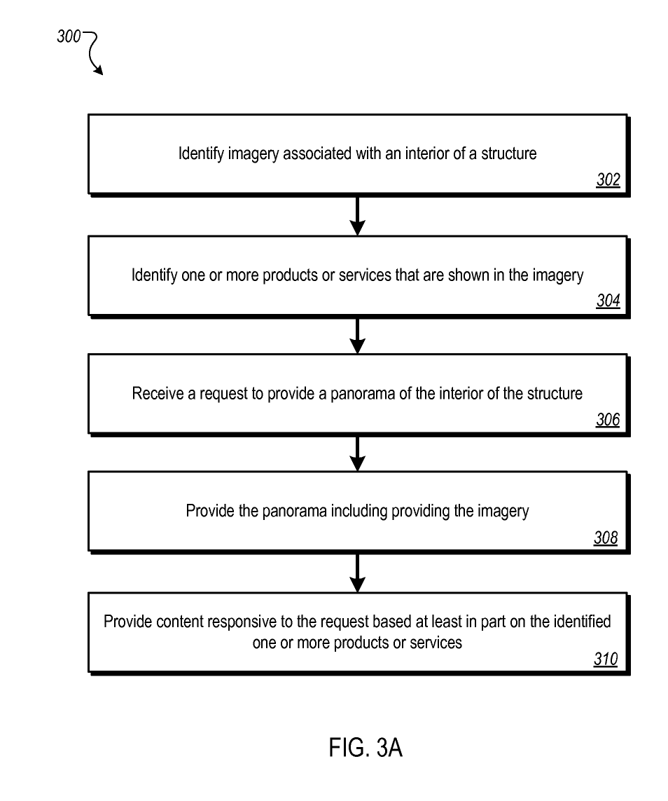

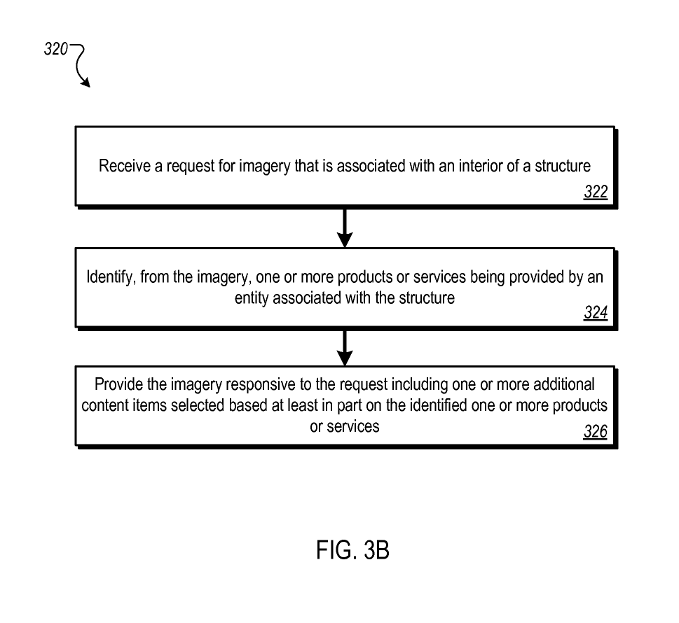

FIG. 3A is a flowchart of an example process 300 for providing content associated with products or services included in interior imagery. The process 300 can be performed by the content management system 110. FIG. 2 is used to provide examples for steps of the process 300.

Imagery associated with an interior of a structure is identified (302). For example, the merchant who owns Wxyz Electronics can use an Internet-based application (e.g., interfaced with the imagery identification engine 224) to associate imagery showing products on Wxyz Electronics shelves with the structure that houses the store. Imagery associations can be stored in or associated with the interior imagery 124.

One or more products or services that are shown in the imagery are identified (304). For example, once the interior imagery has been associated with Wxyz Electronics, the merchant can use Internet-based applications that interface with the product/service identification engine 226, for example, to identify one or more products (e.g., Brand-Q flat-screen TVs 212) or services that are shown in the imagery. Other means can be used to identify products or services shown in the imagery (e.g., automatic means). In some implementations, information for products or services depicted in the imagery, including keywords associated with the products or services, can be included with information stored in the interior imagery 124.

A request is received to provide a view (e.g., a panorama) of the interior of the structure (306). For example, the content management system 110 can receive the request for panorama data 232, e.g., when the user starts the view application 208.

The view is provided, including providing the imagery (308). As an example, the content management system 110 can provide panorama and imagery 234 in response to the request 232. In some implementations, the request handler 220 can handle the request by receiving the request 232 and providing the panorama and imagery 234 in response.

A request is received for content related to the view. For example, the content management system 110 can receive the request for content 236 from the view application 208. In some implementations, the request for content 236 can occur at the same time as the request to provide a view. In some implementations, the request for content 236 can be sent whenever new imagery is displayed in the viewport 210 by the view application 208. In some implementations, the request for content 236 can serve as a request for one or more ads that are associated with products or services displayed or included in the imagery. For example, an ad request can include keywords associated with Brand-Q flat-screen TVs 212.

Content responsive to the request is provided based at least in part on the identified one or more products or services (310). For example, in response to the request for content 236, the content management system 110 can provide content items 202 (e.g., ads) associated with the imagery. The selection of the content items 202 can be based, at least in part, on keywords associated with products or services depicted in the imagery. The content items 202 can be used to fill content item slots 204. In some implementations, the keywords can be determined from metadata that accompanies the imagery, where the metadata can identify, for example, the products or services associated with the imagery.

In some implementations, content responsive to the request for content can be based at least in part on the identified one or more products or services. In some implementations, the process includes evaluating one or more eligible content items. For example, in some implementations, the one or more eligible content items can be ranked based on one or more criteria including, for example, keywords associated with products or services included in the imagery.

In some implementations, the content items selected can be based, at least in part, on conducting an auction. The auction can include evaluating bids of one or more entities (e.g., stores, businesses, etc.) that have targeted bids to the identified one or more products or services, and providing content based on a result of the auction. For example, the inclusion of an ad for Brand-Q flat-screen TVs with the content items 202 (or as the single content item 202) can be based on the results of an auction that selects the Brand-Q flat-screen TV ad over other ads in the auction.

FIG. 3B is a flowchart of an example process 330 for providing imagery and content items associated with products or services included with imagery associated with the interior of a structure. The process 330 can be performed, for example, by the content management system 110. FIG. 2 is used to provide examples for steps of the process 330.

A request for imagery associated with an interior of a structure is received (322). For example, a user using the view application 208 can select Wxyz Electronics as the structure for which to display interior imagery. In some implementations, selecting the structure can occur when the user selects (e.g., clicks on) a structure that is displayed in a street view application. In some implementations, the user's client device 106 can be running a dedicated interior imagery view application (e.g., the view application 208), and the user can specify the name or location of a structure for which the user wishes to view interior imagery. In some implementations, the user can select the structure from a map displayed on the user device 106. In preparation for displaying the imagery in the viewport 210, for example, the view application 208 can provide the request for panorama data 232 to the content management system 110. The request for panorama data 232 can identify the Wxyz Electronics building, for example, as the structure for which interior imagery is to be selected. In some implementations, the request for panorama data 232 can be handled by the request handler 220.

One or more products or services are identified from the imagery as being provided by an entity associated with the structure (324). For example, metadata associated with the imagery can identify the products or services (e.g., televisions, phones and cameras) that are included in the imagery. Further, the entity Wxyz Electronics can be identified as the entity that provides, or is associated with, the products or services.

Imagery responsive to the request is provided including one or more additional content items selected based at least in part on the identified one or more products or services (326). For example, the content management system 110 can provide content items 202 (e.g., ads for Brand-Q flat-screen TVs 212) in response to the request for panorama data 232. The selection of the content items 202 can be based at least in part on keywords associated with products or services depicted in the imagery, including keywords such as “Brand-Q,” “flat-screen,” “TV,” “television” and so on. The content items 202 can be used to fill content item slots 204.

In some implementations, a process can be used for targeting content to users who view interior imagery. The process can include the following steps, e.g., using examples described above with reference to FIGS. 2-3B. Imagery associated with an interior of a structure is received. Identified from the imagery are one or more products or services that are provided by a merchant associated with the structure. Content is targeted to users that view the imagery, including providing one or more content items to a user coincident with or after display of the imagery. The targeting is based at least in part on the identified one or more products or services.

In some implementations, a process can be used for providing imagery responsive requests for imagery. The process can include the following steps, e.g., using examples described above with reference to FIGS. 2-3B. A request is received for imagery associated with an interior of a structure. Identified from the imagery are one or more products or services that are provided by an entity associated with the structure. Imagery responsive to the request is provided, including providing one or more additional content items selected based at least in part on the identified one or more products or services.

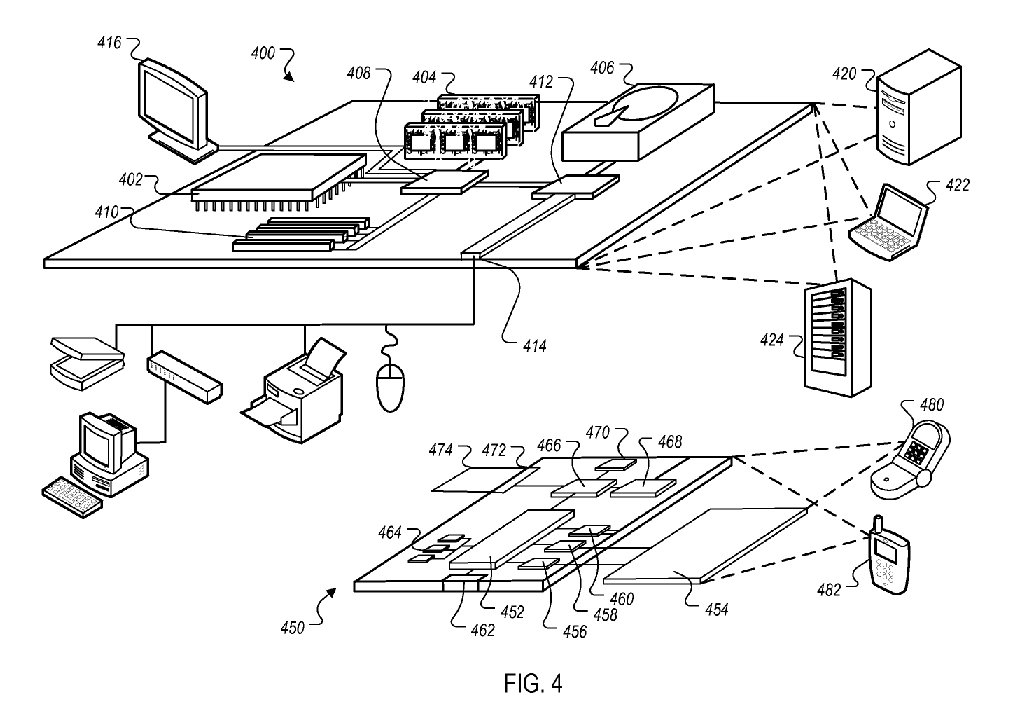

FIG. 4 is a block diagram of computing devices 400, 450 that may be used to implement the systems and methods described in this document, as either a client or as a server or plurality of servers. Computing device 400 is intended to represent various forms of digital computers, such as laptops, desktops, workstations, personal digital assistants, servers, blade servers, mainframes, and other appropriate computers. Computing device 450 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 400 includes a processor 402, memory 404, a storage device 406, a high-speed interface 408 connecting to memory 404 and high-speed expansion ports 410, and a low speed interface 412 connecting to low speed bus 414 and storage device 406. Each of the components 402, 404, 406, 408, 410, and 412, are interconnected using various busses, and may be mounted on a common motherboard or in other manners as appropriate. The processor 402 can process instructions for execution within the computing device 400, including instructions stored in the memory 404 or on the storage device 406 to display graphical information for a GUI on an external input/output device, such as display 416 coupled to high speed interface 408. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 404 stores information within the computing device 400. In one implementation, the memory 404 is a computer-readable medium. In one implementation, the memory 404 is a volatile memory unit or units. In another implementation, the memory 404 is a non-volatile memory unit or units.

The storage device 406 is capable of providing mass storage for the computing device 400. In one implementation, the storage device 406 is a computer-readable medium. In various different implementations, the storage device 406 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 404, the storage device 406, or memory on processor 402.

The high speed controller 408 manages bandwidth-intensive operations for the computing device 400, while the low speed controller 412 manages lower bandwidth-intensive operations. Such allocation of duties is exemplary only. In one implementation, the high-speed controller 408 is coupled to memory 404, display 416 (e.g., through a graphics processor or accelerator), and to high-speed expansion ports 410, which may accept various expansion cards (not shown). In the implementation, low-speed controller 412 is coupled to storage device 406 and low-speed expansion port 414. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. It may also be implemented as part of a rack server system 424. In addition, it may be implemented in a personal computer such as a laptop computer 422. Alternatively, components from computing device 400 may be combined with other components in a mobile device (not shown), such as device 450. Each of such devices may contain one or more of computing device 400, 450, and an entire system may be made up of multiple computing devices 400, 450 communicating with each other.

Computing device 450 includes a processor 452, memory 464, an input/output device such as a display 454, a communication interface 466, and a transceiver 468, among other components. The device 450 may also be provided with a storage device, such as a microdrive or other device, to provide additional storage. Each of the components 450, 452, 464, 454, 466, and 468, are interconnected using various buses, and several of the components may be mounted on a common motherboard or in other manners as appropriate.

The processor 452 can process instructions for execution within the computing device 450, including instructions stored in the memory 464. The processor may also include separate analog and digital processors. The processor may provide, for example, for coordination of the other components of the device 450, such as control of user interfaces, applications run by device 450, and wireless communication by device 450.

Processor 452 may communicate with a user through control interface 458 and display interface 456 coupled to a display 454. The display 454 may be, for example, a TFT LCD display or an OLED display, or other appropriate display technology. The display interface 456 may comprise appropriate circuitry for driving the display 454 to present graphical and other information to a user. The control interface 458 may receive commands from a user and convert them for submission to the processor 452. In addition, an external interface 462 may be provide in communication with processor 452, so as to enable near area communication of device 450 with other devices. External interface 462 may provide, for example, for wired communication (e.g., via a docking procedure) or for wireless communication (e.g., via Bluetooth or other such technologies).

The memory 464 stores information within the computing device 450. In one implementation, the memory 464 is a computer-readable medium. In one implementation, the memory 464 is a volatile memory unit or units. In another implementation, the memory 464 is a non-volatile memory unit or units. Expansion memory 474 may also be provided and connected to device 450 through expansion interface 472, which may include, for example, a SIMM card interface. Such expansion memory 474 may provide extra storage space for device 450, or may also store applications or other information for device 450. Specifically, expansion memory 474 may include instructions to carry out or supplement the processes described above, and may include secure information also. Thus, for example, expansion memory 474 may be provide as a security module for device 450, and may be programmed with instructions that permit secure use of device 450. In addition, secure applications may be provided via the SIMM cards, along with additional information, such as placing identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 464, expansion memory 474, or memory on processor 452.

Device 450 may communicate wirelessly through communication interface 466, which may include digital signal processing circuitry where necessary. Communication interface 466 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 468. In addition, short-range communication may occur, such as using a Bluetooth, WiFi, or other such transceiver (not shown). In addition, GPS receiver module 470 may provide additional wireless data to device 450, which may be used as appropriate by applications running on device 450.

Device 450 may also communicate audibly using audio codec 460, which may receive spoken information from a user and convert it to usable digital information. Audio codec 460 may likewise generate audible sound for a user, such as through a speaker, e.g., in a handset of device 450. Such sound may include sound from voice telephone calls, may include recorded sound (e.g., voice messages, music files, etc.) and may also include sound generated by applications operating on device 450.

The computing device 450 may be implemented in a number of different forms, as shown in the figure. For example, it may be implemented as a cellular telephone 480. It may also be implemented as part of a smartphone 482, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1-25. (canceled)

26. A computer-implemented method, comprising:
identifying, by one or more computing devices, panoramic imagery depicting the interior of a structure, the panoramic imagery depicting one or more products or services, the panoramic imagery being a resource in a content management system;
associating, by the one or more computing devices, the panoramic imagery with a sponsor;
obtaining, by the one or more computing devices, information associated with the one or more products or services depicted in the imagery, the information associated with the one or more products or services being input by the sponsor via a user interface accessible to the sponsor, the information associated with the one or more products or services comprising data indicative of approved content,
annotating, by the one or more computing devices, one or more portions of the panoramic imagery with the information associated with the one or more products or services;
receiving, by one or more computing devices, a request to provide a panorama of the interior of the structure;
providing, by the one or more computing devices, the panorama including providing the imagery;
identifying, by the one or more computing devices, eligible content items based at least in part on the one or more products or services and on the data indicative of approved content; and
providing, by the one or more computing devices, one or more eligible content items for display in conjunction with the panorama.

27. The computer-implemented method of claim 26, wherein the information associated with the one or more products or services comprises a description of the one or more products or services.

28. The computer-implemented method of claim 26, wherein the data indicative of prior approval comprises a description of blacklisted items or entities that should not be eligible content items.

29. The computer-implemented method of claim 26, wherein the data indicative of prior approval comprises a description of whitelisted items or entities that are permissible to be eligible content items.

30. The computer-implemented method of claim 26, wherein providing, by the one or more computing devices, one or more eligible content items for display in conjunction with the panorama comprises:
extracting, by the one or more computing devices, keywords from the information associated with the one or more products or services; and
providing, by the one or more computing devices, one or more eligible content items for display based at least in part on the one or more keywords.

31. The computer-implemented method of claim 26, wherein the products are products included on shelves shown in the imagery.

32. The computer-implemented method of claim 26, wherein the services are services rendered at a location shown in the imagery.

33. A computing system, comprising:
one or more processors; and
one or more memory devices, the one or more memory devices storing computer-readable instructions that when executed by the one or more processors cause the one or more processors to perform operations, the operations comprising:
identifying panoramic imagery depicting the interior of a structure, the panoramic imagery depicting one or more products or services, the panoramic imagery being a resource in a content management system;
associating the panoramic imagery with a sponsor;
obtaining information associated with the one or more products or services depicted in the imagery, the information associated with the one or more products or services being input by the sponsor via a user interface accessible to the sponsor, the information associated with the one or more products or services comprising data indicative of approved content,
annotating one or more portions of the panoramic imagery with the information associated with the one or more products or services;
receiving a request to provide a panorama of the interior of the structure;
providing the panorama including providing the imagery;
identifying eligible content items based at least in part on the one or more products or services and on the data indicative of approved content; and
providing one or more eligible content items for display in conjunction with the panorama.

34. The computing system of claim 33, wherein the information associated with the one or more products or services comprises a description of the one or more products or services.

35. The computing system of claim 33, wherein the data indicative of prior approval comprises a description of blacklisted items or entities that should not be eligible content items.

36. The computing system of claim 33, wherein the data indicative of prior approval comprises a description of whitelisted items or entities that are permissible to be eligible content items.

37. The computing system of claim 33, wherein the operation of providing one or more eligible content items for display in conjunction with the panorama comprises:
extracting keywords from the information associated with the one or more products or services; and
providing one or more eligible content items for display based at least in part on the one or more keywords.

38. The computing system of claim 33, wherein the products are products included on shelves shown in the imagery.

39. The computing system of claim 33, wherein the services are services rendered at a location shown in the imagery.

40. One or more tangible, non-transitory computer-readable media comprising computer-readable instructions that when executed by one or more processors cause the one or more processors to perform operations, the operations comprising:
associating the panoramic imagery with a sponsor;
obtaining information associated with the one or more products or services depicted in the imagery, the information associated with the one or more products or services being input by the sponsor via a user interface accessible to the sponsor, the information associated with the one or more products or services comprising data indicative of approved content,
annotating one or more portions of the panoramic imagery with the information associated with the one or more products or services;
receiving a request to provide a panorama of the interior of the structure;
providing the panorama including providing the imagery;
identifying eligible content items based at least in part on the one or more products or services and on the data indicative of approved content; and
providing one or more eligible content items for display in conjunction with the panorama.

41. The one or more tangible, non-transitory computer-readable media of claim 40, wherein the data indicative of prior approval comprises a description of blacklisted items or entities that should not be eligible content items.

42. The one or more tangible, non-transitory computer-readable media of claim 40, wherein the data indicative of prior approval comprises a description of whitelisted items or entities that are permissible to be eligible content items.

43. The one or more tangible, non-transitory computer-readable media of claim 40, wherein the operation of providing one or more eligible content items for display in conjunction with the panorama comprises:
extracting keywords from the information associated with the one or more products or services; and
providing one or more eligible content items for display based at least in part on the one or more keywords.

44. The one or more tangible, non-transitory computer-readable media of claim 40, wherein the products are products included on shelves shown in the imagery.

45. The one or more tangible, non-transitory computer-readable media of claim 40, wherein the services are services rendered at a location shown in the imagery.
